(19) United States
(12) Patent Application Publication
(10) Pub. No.: US 2014/0143539 A1
(43) Pub. Date: May 22, 2014

(54) WEB TOKENS WITH A SIGNATURE OF A WEB PAGE VISITOR

(71) Applicant: CONNET d.o.o., Ljubljana (SI)

(72) Inventor: Ales Lipicnik, Strahovica (SI)

(73) Assignee: CONNET d.o.o., Ljubljana (SI)

(21) Appl. No.: 14/129,840

(22) PCT Filed: Jun. 28, 2012
(86) PCT No.: PCT/SI2012/000042

§ 371 Date: Dec. 27, 2013

(30) Foreign Application Priority Data
Jun. 28, 2011 (SI) P-201100230

(51) Int. Cl. H04L 29/06

(52) U.S. Cl. CPC H04L 63/1483
USPC 713/156

(57) ABSTRACT

Web tokens provided with a signature of a web page visitor solve a problem of time-consuming verification of authenticity of web pages. This is a key element for a visitor/user to avoid web fraud. The invention makes it possible for the Internet users to add a personal signature to trust tokens that are often subject to fraud. The user thus immediately sees whether a visited web site is authentic or fake. The visitor of web pages thus avoids the inconvenient following of links, via which authenticity of a web site can usually be verified.

The invention belongs to the field of a safe use of the Internet by a final user—web page visitor.

The subject of the invention is a method for personalisation of a confidence token on web pages, with which granted trusted certificates are usually identified.

Web page visitors (A) are more and more often victims of Internet fraud. A huge part of Internet fraud uses fake web pages that are copies of an original web page of a vendor. Protection and verification of authenticity of web pages are offered by several vendors, the so-called trusted certificate providers (B). By granting a certificate they fully guarantee authenticity of a web page or a web site. The receiver (C) of such a certificate publishes a token on his pages, most often in the form of an image (E). As the images of tokens are very easy to copy, technologically more advanced providers generate them from their server and include a link back to the provider's server. A visitor can click on such token to fully verify authenticity of the token and the page via such a link.

This type of verification is time consuming and the visitors become reluctant to using it. According to this invention, the visitors can register their personal signature with the provider and the provider then displays the signature together with the token. When the visitor sees a signed token, he is immediately convinced that the token is authentic.

The applicant is not acquainted with any similar solutions.

Systems of web site certification are known and have been commercially used for quite a long time. The invention may be applied in any such system that meets the following criteria:
the system comprises three entities: certificate provider (B), certificate receiver (C) and a visitor (A) of the certificate receiver's web page;
the provider (B) has technology (web server and web application) that verifies requests from a visitor's (A) browser to display a token (D). The token is not necessarily an image, yet this is the most common form. The token can be audible or in any other manifestation that a human can sense;
certificate receiver (C) has a web site, on which the token was published in a manner prescribed by the provider (B);
display of the token is requested from the provider's server that also checks whether the request for a display is justified.

The invention is presented with the following figures:

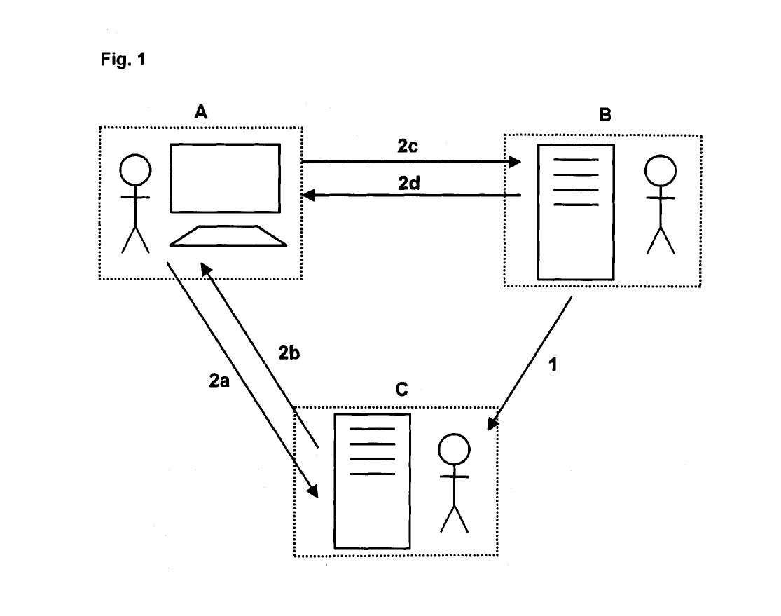

FIG. 1 schematic view of a system of certifying web sites with trusted certificates and includes the participating entities and data transactions.

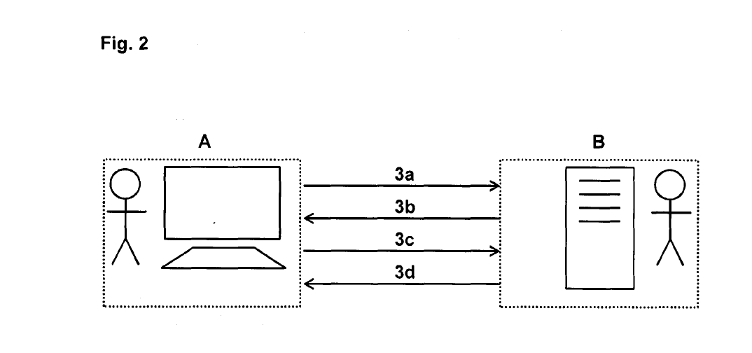

FIG. 2 schematic view of a registration process with the participating entities and data transactions.

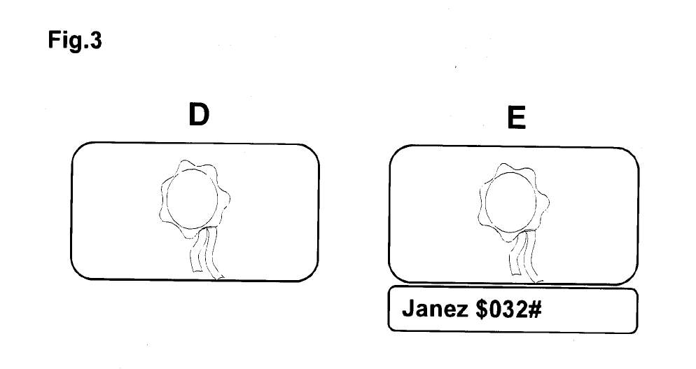

FIG. 3 symbolic image of tokens for a web page with or without a visitor's signature.

A view of internet pages usually starts with a request for viewing pages (2a) initiated by a visitor (A) on his work station by way of a web browser.

The server of the desired page responds with the content of a page (2b). If the page to be displayed is owned by a trusted certificate receiver (C) and provided with a token according to instructions (1) of the certificate provider (B), the browser continues with a request (2c) for the display of a token to the server of the certificate provider (B).

The server of the provider (B) responds with the content of the token (2d) that the visitor's (A) browser then displays or plays.

Once a web page is completely shown in the visitor's (A) browser, the visitor (A) can start verifying the authenticity of the token and consequently of the entire page in order to protect himself against possible fraud.

By using the present invention in such a system, it is possible to add a personal signature of the visitor (A) to the token, said signature enabling the visitor (A) to recognise the authenticity of the token at first sight. The visitor (A) does not have to carry out a time-consuming verification.

To serve this purpose, the provider (B) must allow the visitor (A) to register his personal signature, which is shown in one of possible implementations in FIG. 2.

In this case, the trusted certificate provider (B) offers the visitors (A) a web page, on which they can enter their ‘signature’, for instance in the form of a text. A process is initiated by the visitor's (A) request for a registration page (3a). The provider's server returns (3b) the content of a registration page. The visitor (A) enters his signature into an entry form on the page and submits (3c) it. The provider's server creates a unique data ‘token’ for the received signature and returns (3d) it to the visitor's (A) browser. The browser saves the ‘token’ locally. In its simplest implementation the token can be a ‘cookie’ used by browsers for local storage of data.

There are several possible ways of signing, which differ among themselves in the following:
type of content that serves for the signature (text, image, sound, video or any other form that can be sensed by a human with his senses);
manner of how the content of the signature is registered with the trusted certificate provider (for instance text entry or uploading a file);
manner how the assigned ‘token’ of the signature is stored in the visitor's browser (for instance a ‘cookie’, in the local storage of the browser or in another way);
manner how the signature content is displayed on the token.

After the signature is registered, the provider's (B) server will be forwarded the previously stored signature ‘token’ upon a request (2c) for the display of the token. In the response, the browser will also display the content of the signature apart from the token content. The browser thus shows the token with a signature (E). The visitor recognises his signature ‘at first sight’ and can be sure about the authenticity of the token and the related warranties on the safety of a web page.

1. Web tokens with a signature of a web page visitor that are processed among a group of computers connected via the Internet, wherein this group consists of a visitor (A) from a multitude of possible visitors, a provider (B) of a token (2d) and a trusted certificate receiver (C), characterised in that upon a request for visiting a web page (2a) initiated by the visitor (A) a server of the provider (B) for the web pages displays with the token also the visitor's signature, if said signature had earlier been registered with the provider (B).

2. Web tokens according to claim 1, characterised in that the visitor's (A) signatures can be in the form of a text, graphic, sound or other content that the visitor (A) enters upon registration and on the basis of which the provider's (B) server creates a unique ‘token’ that is returned to the visitor's (A) server that stores it.

3. Web tokens according to claim 1, characterised in that the registered signature is pasted only on the current display of the same visitor (A) when the visitor (A) views any web page with the receiver's (C) certificate stored in the provider's (B) database.

4. Web tokens according to claim 2, characterised in that the registered signature is pasted only on the current display of the same visitor (A) when the visitor (A) views any web page with the receiver's (C) certificate stored in the provider's (B) database.
